(19) United States
(12) Patent Application Publication
(10) Pub. No.: US 2010/0011892 A1
(43) Pub. Date: Jan. 21, 2010

(54) TOOTHED WHEEL

(75) Inventor: Christophe Lassalle, Leigne Les Bois (FR)

Correspondence Address: MATTHEW R. JENKINS, ESQ., 2310 FAR HILLS BUILDING, DAYTON, OH, 45419, US

(73) Assignee: VALEO SYSTEMES D'ESSUYAGE, La Verriere (FR)

(21) Appl. No.: 11/912,928

(22) PCT Filed: Apr. 20, 2006
(86) PCT No.: PCT/EP2006/003631

§ 371 Date: Oct. 1, 2009

(30) Foreign Application Priority Data
Apr. 29, 2005 (FR) 0504396

(51) Int. Cl. F16H 35/00; G01B 5/24

(52) U.S. Cl. 74/388 R; 33/203

(57) ABSTRACT

The invention relates to a toothed wheel comprising a central bore which defines a central rotation axle and a secondary bore in which a crankpin is fixed. The invention is characterized in that one of the faces thereof is equipped with means for determining the distance between the central axle of the central bore and the axle of the crankpin in the secondary bore, the means taking the form of coding means.

### CROSS-REFERENCE TO RELATED APPLICATIONS

This application claims priority to PCT Application PCT/EP2006/003631 filed Apr. 20, 2006 and also to French Application No. 0504396 filed Apr. 29, 2005, which applications are incorporated herein by reference and made a part hereof.

### BACKGROUND OF THE INVENTION

1. Field of the Invention

The present invention relates to a toothed wheel, and more specifically to the production of means for differentiating toothed wheels.

2. Description of the Related Art

More specifically, toothed wheels are currently used for transmitting movement in motors, for example motors for vehicle windscreen wipers, this transmission being carried out by means of a crankpin connected to the connecting rod and guided by a stud located on one of the sides of the toothed wheel.

These toothed wheels are usually made from a molded wheel with an axle shaft passing through it, having a serration on its rim and comprising a recess on one of its sides into which a cam can be inserted.

These wheels are generally connected by a system of mobile parts to an output drive shaft, for example a drive arm of a windscreen-wiper arm in the case of windscreen-wiper motors.

In a standard manner, the distance between the rotation axle of the toothed wheel and the axle of the crankpin, fixed to one of the sides of the toothed wheel, commonly called “center distance”, makes it possible to determine the output rotational angle of the drive shaft connected, for example, to a windscreen-wiper arm.

For this reason, it is important to know the value of this center distance so as to determine the output rotational angle of the drive shaft and, therefore, the wiping angle of the windscreen-wiper arm in the case of a windscreen-wiper motor.

However, due to the relatively small size of the motor parts, it is often difficult to judge this center distance with the unaided eye, it generally being approximately one centimeter and varying only by a few millimetres to achieve different rotational angles.

A first quantification method consists of manually measuring the center distance using a ruler or a measuring device, which does not, however, allow for a suitably precise and reliable measurement, due to the margin of error inherent in a manual measurement.

An alternative solution consists of manufacturing electronic devices, for example, for optically measuring this center distance.

However, these devices are relatively difficult to install, expensive and susceptible to malfunctions.

In order to solve these problems, it is known in the prior art to incorporate coloring pigments in the base material which constitutes the wheel, each color corresponding to a given center distance.

However, in addition to the fact that the number of colors recognized by the human eye is limited and subject to error for colors with similar shades, it should be noted that adding pigments to the base material of the wheels also modifies the intrinsic characteristics of the material.

It would therefore be particularly advantageous to make differentiation means for a toothed wheel which can easily be understood by human beings, requiring only one mold for forming the wheel and not causing a modification of the intrinsic properties of the base material of the wheel.

Furthermore, in windscreen-wiper motors, the wheels and the cam they use are different according to the wiping direction and the configuration of the motor.

Indeed, according to the space available for fixing a motor, for example of a windscreen wiper, it can be of the “right” or “left” type.

In the same way, according to the wiping direction of the windscreen-wiper arm, the motor is said to have a right-fixed stop or a left-fixed stop.

The difference between these types of motors affects the cam connected to the surface of the toothed wheel.

It is currently impossible for those skilled in the trade to determine whether the wheel is designed for a right or left motor or for a right- or left-fixed stop motor directly by looking at the wheel, and in particular the side of the wheel in which the cam is inserted.

It would therefore be particularly advantageous also to produce means for differentiating toothed wheels which make it possible, in addition to simply determining the center distance of the wheel, to determine the type of motor in which the wheel is integrated.

### SUMMARY OF THE INVENTION

The present invention aims to solve the problems of the prior art with a toothed wheel having easily understandable differentiation means which do not require a complex molding process and are inexpensive.

The present invention relates to a toothed wheel with a central bore defining a central rotation axle and a secondary bore designed for fixing a crankpin, characterized in that one of its sides is equipped with means for determining the distance between the central axle of the central bore and the axle of the crankpin in the secondary bore, the determination means taking the form of coding means made from a plurality of protruding elements arranged on the side of the wheel on which the crankpin is fixed.

In an advantageous manner, the protruding elements are substantially cylindrical and at least one of the protruding elements has a transversal wall forming a diameter of this protruding element.

In order to further differentiate certain characteristics of the toothed wheels, a bore is made in the bottom of at least one of the protruding elements.

The protruding elements are located on a single circle centered on the central bore so as to allow homogeneous molding of the wheel.

The present invention also relates to a method of differentiating a toothed wheel according to the previous characteristics, characterized in that it comprises a step of reading a binary code according to the presence or absence of a wall in the protruding elements as well as a step of determining a characteristic of the toothed wheel in relation to the presence or absence of a bore in the bottom of the protruding elements.

These and other objects and advantages of the invention will be apparent from the following description, the accompanying drawings and the appended claims.

### BRIEF DESCRIPTION OF THE ACCOMPANYING DRAWINGS

The present invention is described below with the help of merely illustrative examples that do not limit the scope of the present invention, and according to the following drawings, in which:

FIG. 1 shows a perspective view of the toothed wheel connected by a crankpin to a connecting rod and having coding means according to the invention;

FIG. 2 shows a bottom perspective view of a toothed wheel connected to a cam;

FIG. 3 is a perspective view of a toothed wheel with the coding means according to the invention;

FIG. 4 is a top view of a toothed wheel with the coding means according to the invention; and

FIGS. 5 and 6 are more detailed top views of the coding means of a wheel according to the invention.

### DETAILED DESCRIPTION OF AN ILLUSTRATIVE EMBODIMENT

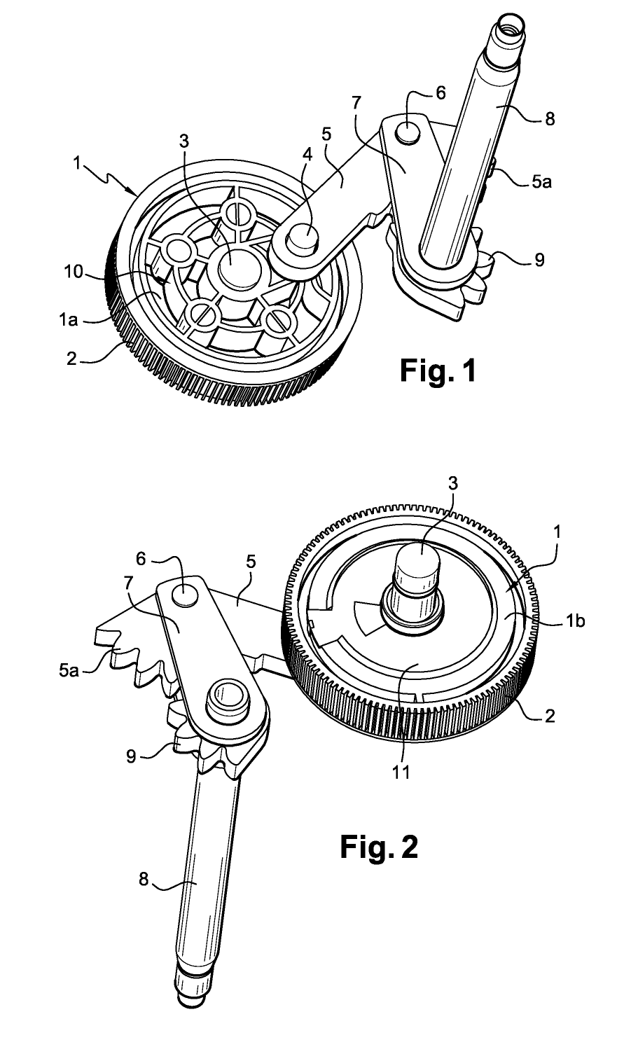

FIG. 1 is a perspective view of a wheel 1 with gear teeth 2 on its peripheral rim and a rotation axle 3 at its center.

A bore (not shown in FIG. 1) is made in one side 1 a of the wheel 1, called the crankpin fixing side 1 a, in which a crankpin 4, of a known type, is inserted.

The crankpin 4 itself is inserted in the end of a connecting rod 5, the other end of which is connected by a second crankpin 6 to two swivel levers 7 of a known type.

The swivel levers 7 are guided by an output axle 8, the rotational angle of which is determined in particular by the rotational angle of the wheel 1 and the movement which is thus transferred, the toothed end 5a of the connecting rod 5 being capable of engaging with a toothed end sector 9 of the output axle 8.

The side 1a fixing the crankpin 4 has coding means 10 according to the invention, the embodiment of which will be detailed later.

FIG. 2 shows a perspective view of the side 1b of the wheel 1 in which a cam 11 of a known type is inserted.

The shape of the cam 11 determines whether the wheel 1 is designed for a windscreen-wiper motor of left or right type or of left- or right-fixed stop type.

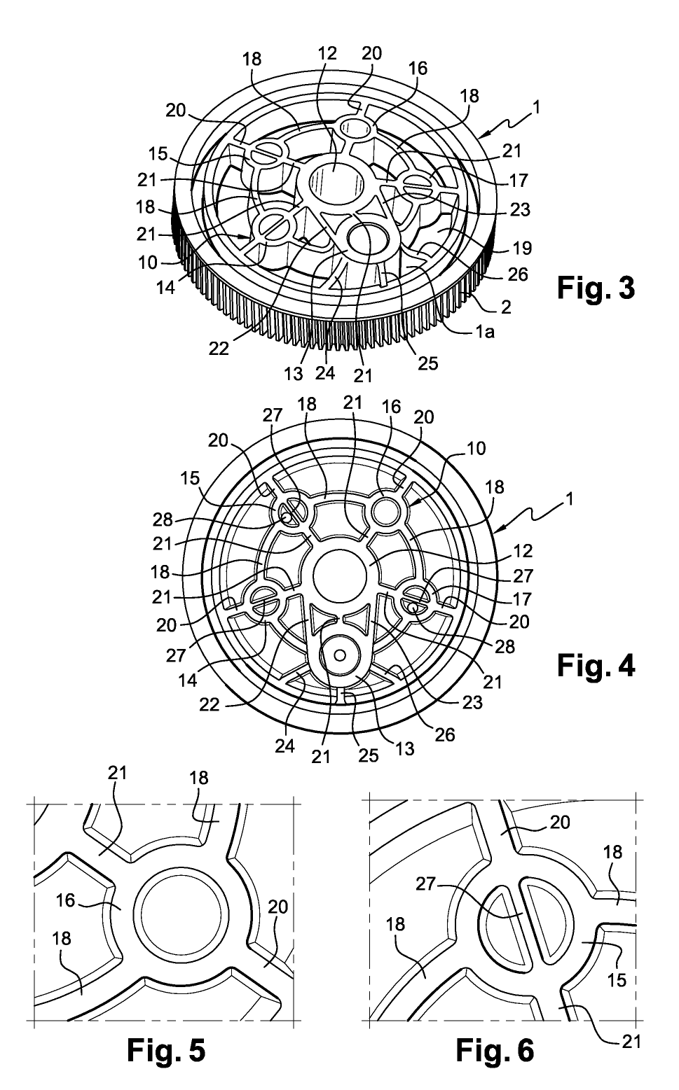

FIG. 3 shows a perspective view of the wheel 1 with the coding means 10 according to the invention.

The wheel 1 has a central bore 12 forming a sleeve or boss designed for the central rotation axle 3 as well as a secondary bore 13, also forming a sleeve or boss, designed for fixing the crankpin 4 to the wheel 1 and defining the axle of the crankpin 4.

The distance between the central rotation axle 3 and the axle of the crankpin 4 is commonly known as the “center distance” and is used to determine the rotational angle of the output shaft 8, for example the wiping angle of the windscreen-wiper arm in the case where the toothed wheel 1 is incorporated in a windscreen-wiper motor.

The coding means 10 on the so-called crankpin fixing side 1a of the wheel 1 form a number of protruding elements (14, 15, 16, 17), advantageously forming four substantially cylindrical protruding elements (14, 15, 16, 17).

These protruding elements (14, 15, 16, 17) are advantageously located on a single circle centered on the central bore 12 of the rotation axle 3 of the wheel 1 and are connected to each other by curved walls 18.

Additionally, the secondary bore 13 is also located on the same circle.

More specifically, the fixing side 1a of the wheel 1 has a circular inner hollowing 19 against which the protruding elements (14, 15, 16, 17) and the curved walls rest.

Walls in the form of parallelepipedal elements 20 are also formed between the periphery of the circular inner hollowing 19 and the circular protruding elements (14, 15, 16, 17).

These parallelepipedal elements 20 are said to be “external” as they are located outside the circle defined by the cylindrical protruding elements (14, 15, 16, 17) and are substantially radial in relation to the central rotation axle 3 of the wheel 1, which is to say they are located on a spoke of the wheel 1.

Walls are also provided in the form of protruding parallelepipedal elements 21 between the central bore 12 and each of the cylindrical protruding elements (14, 15, 16, 17) as well as between the secondary bore 13 and the central bore 12.

These parallelepipedal elements 21 are said to be “internal” as they are located inside the circle defined by the circular protruding elements (14, 15, 16, 17) and are substantially radial in relation to the central rotation axle 3 of the wheel 1, which is to say they are located on a spoke of the wheel 1.

Furthermore, a pair of parallel walls (22, 23) are provided which connect the secondary bore 13 to the main bore 12 as well as a plurality of walls (24, 25, 26) between the inner perimeter of the internal hollowing 19 of the fixing side 1a and the sleeve of the secondary bore 13.

In the rest of the description, “bottom” protruding elements will be understood to mean protruding elements (14, 17) which are directly connected by a curved wall 18 to the boss of the secondary bore 13 and “top” protruding elements will be understood to mean protruding elements (15, 16) which are directly connected, only by curved walls 18, to another protruding element (14, 15, 16, 17) and not to the sleeve of the secondary bore 13.

Thus, two top protruding elements (15, 16) and two bottom protruding elements (14, 17) are shown in the figures.

Those skilled in the trade will, however, be capable of modifying the number of protruding elements (14, 15, 16, 17) present on the fixing side 1a of the wheel 1.

In this way, it is possible to produce wheels 1 with a single protruding element or even with more than four protruding elements.

Each protruding element (14, 15, 16, 17) can possibly contain a transversal wall 27 advantageously forming a substantially radial diameter of the protruding element (14, 15, 16, 17), which is to say it is located on a spoke of the wheel 1, and connecting the so-called “inner” protruding wall 21 to the so-called “outer” protruding wall 20.

In the same way, it is also possible to provide bores 28 passing through the toothed wheel 1, advantageously associated with each protruding element (14, 15, 16, 17), and more advantageously provided in the bottom of each protruding element (14, 15, 16, 17).

The cylindrical protruding elements (14, 15, 16, 17) are coding means 10 making it possible in a simple manner to determine the wheel/crankpin center distance.

Indeed, each protruding element (14, 15, 16, 17) is assigned a binary code, either 0 or 1, according to the absence or presence of the transversal wall 27 in the protruding element (14, 15, 16, 17).

Thus, by convention, the number 0 is assigned to a protruding element (14, 15, 16, 17) which does not have a transversal wall and the code 1 is assigned to a protruding element (14, 15, 16, 17) which does have a transversal wall 27.

It is understood that the opposite is also possible, which is to say the assignment of a code 0 for the presence of a transversal wall 27 and a code 1 for the absence of a transversal wall 27.

Also by convention, the binary codes of the protruding elements (14, 15, 16, 17) are read in the clockwise direction, beginning with:

the bottom protruding element 14 connected by a curved wall 18 to the boss of the secondary bore 13 and located to the left of this boss 13 when the user is facing the fixing side of the wheel 1 with this secondary bore boss 13 directed towards the user, then

the top protruding element 15 located to the left of the user, also with the secondary bore boss 13 directed towards the user, then

the top protruding element 16 located to the right of the user with the secondary bore boss 13 directed towards the user, and finally

the bottom protruding element 17 located to the right of the user with the secondary bore boss 13 directed towards the user.

Alternatively, it is understood that the binary codes of the protruding elements (14, 15, 16, 17) can also be read in the counter-clockwise direction, starting with the bottom right protruding element 17.

Thus, assigning 0 to a protruding element (14, 15, 16, 17) which does not have a transversal wall 27, FIGS. 3 and 4 show a wheel 1 with the binary code 1101, this code corresponding to a given center distance and a given output angle.

It is understood that those skilled in the trade will be able to modify the four-digit binary code for a given center distance and a given output angle.

Indeed, based on a wheel with four protruding elements, it is possible to obtain 2⁴=16 different binary codes and therefore to differentiate sixteen different center distances and output angles.

Those skilled in the trade will evidently understand that it is possible to make more or fewer cylindrical protruding elements (14, 15, 16, 17) in relation to the number of figures and binary codes required to thereby differentiate a larger or smaller number of center distances.

Additionally, so as to differentiate the types of motors in which the toothed wheel 1 is to be integrated, it is possible to make the bore 28 in the bottom of the protruding elements (14, 15, 16, 17), which is to say in the inner space of the fixing side 1a of the wheel 1 defined by each protruding element (14, 15, 16, 17).

By convention, it is decided that a bore 28 made in the top protruding elements (15, 16) is used to determine whether the motor is of the right or left type, the bore 28 being made in the bottom of the top left protruding element 15 when the wheel 1 is designed to be integrated in a left-type motor and the bore 28 being made in the bottom of the top right protruding element 16 when the wheel 1 is designed to be integrated in a right-type motor.

In the same way, also by convention, it is decided that a bore 28 made in the bottom protruding elements (14, 17) is used to determine whether the motor is of the right- or left-fixed stop type, the bore 28 being made in the bottom of the bottom left protruding element 14 when the wheel 1 is designed to be integrated in a left-fixed stop motor and the bore 28 being made in the bottom of the bottom right protruding element 17 when the wheel 1 is designed to be integrated in a right-fixed stop motor.

Thus, the wheel 1 such as depicted in FIG. 4 is designed to be integrated in a left-type motor with a right-fixed stop.

It is understood that those skilled in the trade will be able to assign any meaning whatsoever to the characteristics of the toothed wheel 1, or any other element in relation to the toothed wheel 1, according to the absence or presence of a bore 28 in the bottom of the protruding elements (14, 15, 16, 17), and more specifically in the inner space of the fixing side 1a of the wheel 1 defined by each protruding element (14, 15, 16, 17).

It is therefore clearly easier to differentiate the toothed wheels 1 and quickly to determine the type of motor in which they are designed to be integrated.

The same is true for determining the center distance using a correlation table between the binary code, the center distance and the output angle which the user can either memorize or consult to determine the center distance.

Errors in measurement and in reading the center distance and therefore the rotational angle of the output drive shaft are thereby prevented.

Furthermore, in order to facilitate the reading direction of the coding means (10), a logo or an inscription is added between the two top protruding elements (15, 16); this logo or inscription must be positioned horizontally and the right way up when the user reads the coding means (10) in the clockwise direction and beginning with the bottom left protruding element 14 and ending at the bottom right protruding element 17.

Furthermore, toothed wheels are therefore advantageously produced with coding means which can be machined using a single tool and which can be ground up.

Indeed, it is possible easily to modify the mold for forming the toothed wheel 1 to integrate the presence or absence of transversal walls 27 inside the protruding elements (14, 15, 16, 17).

Furthermore, the ground powder obtained after grinding the wheels 1 can be re-used, which was not the case in the prior art when adding coloring pigments.

While the methods herein described, and the form of apparatus for carrying these methods into effect, constitute preferred embodiments of this invention, it is to be understood that the invention is not limited to these precise methods and form of apparatus, and that changes may be made in either without departing from the scope of the invention, which is defined in the appended claims.

What is claimed is:

1. A toothed wheel having a central bore defining a central rotation axle and a secondary bore in which a crankpin is fixed, wherein said toothed wheel comprises on at least one side thereof determination means for determining a distance between a central axle of said central bore and an axle of said crankpin in said secondary bore.

2. The toothed wheel according to claim 1, wherein said determination means are in the form of coding means.

3. The toothed wheel according to claim 1, wherein said determination means are in a form of a number of protruding elements arranged on said at least one side of said toothed wheel to which said crankpin is fixed.

4. The toothed wheel according to claim 3, wherein said protruding elements are substantially cylindrical.

5. The toothed wheel according to claim 3, wherein at least one of said protruding elements has a transversal wall.

6. The toothed wheel according to claim 5, wherein said transversal wall forms a diameter of said at least one of said substantially cylindrical protruding elements.

7. The toothed wheel according to claim 3, wherein a bore is made in a bottom of at least one of said protruding elements.

8. The toothed wheel according to claim 3, wherein said protruding elements are located on a single circle centering on said central bore.

9. A method of differentiating said toothed wheel according to claim 3, wherein said method comprises a step of reading a binary code according to the presence or absence of a wall in said protruding elements.

10. A method of differentiating said toothed wheel according to claim 9, wherein said method comprises a step of determining a characteristic of said toothed wheel according to the presence or absence of a bore in the bottom of said protruding elements.

11. A method for differentiating toothed wheels comprising the steps of:
determining a characteristic for each of a plurality of toothed wheels;
molding a plurality of toothed wheels to have at least one protrusion that corresponds to identify its respective characteristic.

12. The method as recited in claim 11, wherein said characteristic is a distance between a central axle of a central bore and an axle of a crankpin in a secondary bore.

13. The method as recited in claim 11, wherein said characteristic is a distance between a central axle of a central bore and an axle of a crankpin in a secondary bore, said method further comprising the step of:
using said at least one protrusion to determine a binary code identifying said characteristic for each of said plurality of toothed wheels.

14. The method as recited in claim 11, wherein said characteristic is a distance between a central axle of a central bore and an axle of a crankpin in a secondary bore, said method further comprising the steps of:
molding a plurality of protrusions in each of said plurality of toothed wheels, each of said plurality of toothed wheels having a different number of said plurality of protrusions in order to identify said characteristic associated for toothed wheel.

15. The method as recited in claim 14, wherein at least one of said plurality of protrusions comprises a transversal wall.

16. The method as recited in claim 14, wherein a bore is made in a bottom of at least one of said plurality of protrusions.

17. The method as recited in claim 14, wherein said method further comprises the step of:
molding said plurality of protrusions are molding in a circle in each of said plurality of toothed wheels.

18. The method as recited in claim 14, wherein said method further comprises the step of:
determining said characteristic of each of said plurality of toothed wheels according to a presence or absence of a bore in said plurality of protrusions.
